(19) United States
(12) Patent Application Publication
(10) Pub. No.: US 2025/0012144 A1
(43) Pub. Date: Jan. 9, 2025

(54) PULL CORD RELEASE WHEEL FOR WINDOW BLINDS SPRING MOTOR

(71) Applicants: Hsien-Te HUANG, Taipei City (TW); Yu-Wei HUANG, Taipei City (TW)

(72) Inventors: Hsien-Te HUANG, Taipei City (TW); Yu-Wei HUANG, Taipei City (TW)

(21) Appl. No.: 18/887,938

(22) Filed: Sep. 17, 2024

Related U.S. Application Data
(63) Continuation-in-part of application No. 17/556,073, filed on Dec. 20, 2021.

(30) Foreign Application Priority Data
Nov. 3, 2021 (TW) 110212917

(51) Int. Cl. E06B 9/322

(52) U.S. Cl. CPC E06B 9/322

(57) ABSTRACT

A pull cord release wheel for window blinds spring motor, and provides a release wheel for a spring motor of a curtain unit for winding a pull cord. The release wheel is mainly configured with a ridge at the corner joint position of a spoke, and pull cord access holes penetrate through a tread along with a planar ring spoke. Two through holes are formed on the tread enabling passage to the two side surfaces thereof, and an open space is provided at the outlet directions of the through holes. An outer circumference ridge surface of the ridge is used to take up a bunching force generated by a final winding of a second layer winding during the ascending process of a change in reverse winding of a third layer winding, thereby preventing squeezing a first winding that has been wound as an inner layer causing disordered winding.

### RELATED APPLICATION

This application is a Continuation-in-Part of currently pending U.S. patent application Ser. No. 17/556,073 filed on 2021 Dec. 20.

### BACKGROUND OF THE INVENTION

### (a) Field of the Invention

The present invention relates to a pull cord release wheel for window blinds spring motor, and provides a release wheel for a spring motor of a curtain unit for winding a pull cord. The release wheel is configured with a ridge that enables preventing a bunching force generated when a final winding loop of a second layer winding is preparing to ascend for the reverse cross winding of a third layer winding during operation from causing misalignment of a winding layer of a first winding by means of a gap, thereby maintaining orderly winding and providing a stable speed for winding and unwinding the pull cord.

### (b) Description of the Prior Art

Referring to FIG. 1, which shows a window blind set 10 for horizontal raising/lowering of curtain blinds 70, where a basic configuration of the window blind set 10 is illustrated. The upper end of the window blind set is fitted with a top rail 71 and the lower end is fitted with a bottom rail 72, with the curtain blinds 70 being interactive movable linked between the two. Lower ends of left and right pull cords 20 are joined to the bottom rail 72, and upper ends are connected to a torque feedback device 80 by means of a turning element 73. The torque feedback device 80 is centrally fitted with a reaction unit 86, the two sides of which respectively connectively drive two side release wheels 90, which enable the winding and unwinding of the pull cords 20. The reaction unit 86 is further fitted with a constant pressure coil spring 85. During the process of a user pulling down the bottom rail 72 and releasing the curtain blinds 70, the release wheels 90 are also connectively driven, and the torque converted by the release wheels 90 then drives the reaction unit 86, which indirectly causes torsional turning of the constant pressure coil spring 85 to reversely wind round and acquire an elastic feedback energy storage. This kind of system requires that the winding and unwinding speed of the two side pull cords 20 be equal, otherwise, the connectively driven bottom rail 72 will deviate from the horizontal and become skewed.

The shading angles of shade slats 74 of the curtain blinds 70 need to be adjustable, with uses left and right structures that are mainly “H” shaped. The shade slats 74 are successively joined from the top to the bottom by wooden or bamboo ladder-like ladder cords 77, and two corresponding ends of each of the shade slats 74 are connected to the respective ladder-like ladder cords 77 so that the shade slats 74 are equally spaced from top to bottom. The upper ends of the left and right ladder cords 77 are respectively connected to left and right angular position adjusting devices 75, and a driving rod 76 is linked between the two angular position adjusting devices 75 to enable synchronous driving thereof. Such a driving method allows the user to use their hands to respectively pull a left cord hoop 781 or a right cord hoop 782 to drive and clockwise/counterclockwise rotate a tilt pulley 40, whereby the rotation drives the front and rear strands of the ladder cords 77 (not shown in the drawings), to realize an up/down corresponding change thereto, achieving a front/rear change in the shading angle of the shade slats 74.

The angular position adjusting device 75 is normally installed on the right side, and driven by a drive cord loop 78 through manual operation, which drives the ladder cords 77 to effect an up/down synchronous adjustment of each of the shade slats 74, including changing the shading angle of the bottom rail 72.

The main requirements for the window blind set 10 include the winding/unwinding lengths of the two side pull cords 20 wound/unwound by the two side release wheels 90 being equal, so as to maintain a horizontal state of the bottom rail 72 at any height position.

Referring to FIG. 2, the following first explains the structural basis of the torque feedback device 80, which is structured from an upper frame plate 81, the bottom portion of which has a corresponding lower frame plate 82. The interior of the torque feedback device 80 is configured with the reaction unit 86, which is formed by the constant pressure coil spring 85 mutually connected between a retrieval wheel 83 and a pick-up wheel 84. The bottom portions of the retrieval wheel 83 and the pick-up wheel 84 are fitted with gear wheels 830 and 840, respectively, which respectively outwardly mesh with gear wheels 91 of the release wheels 90, causing the four wheels to achieve a mutual linkage effect. When the curtain blinds 70 are pulled down (as shown in FIG. 1), the two pull cords 20 are connectively driven, thereby pulling the two release wheels 90. The torque force generated by the release wheels 90 being pulled is transmitted to the reaction unit 86 through the meshing of the gear wheels 830 and 840. The reaction unit 86 reversely winds the constant pressure coil spring 85 onto the pick-up wheel 84, at the same time generating and storing elastic reaction energy. The stored energy is used as feedback output for when the curtain blinds 70 are raised, converting the stored energy into motive force to upwardly gather up the curtain blinds 70.

Referring to FIG. 3, which shows the spooling of laminated windings 30, and is an ideal state for sequential windings, wherein one end of the release wheel 90 is configured with the gear wheel 91, the other end is a spoke 93, and a tread 92 enables the pull cord 20 to be wound thereon. The pull cord 20 emerges from the position of a start winding end 300, and winds round the surface of the tread 92 at helical angles to form a first layer winding 31. After the last loop of the first layer winding 31 contacts an inner spoke side 910 of the gear wheel 91, reverse winding of a second layer winding 32 proceeds. After the last loop of the second layer winding 32 reaches an inner spoke side 930 of a spoke 93, reverse winding of a third layer winding 33 proceeds, thereby forming the laminated windings 30. The winding configuration of the laminated windings 30 is sequentially arranged, thus, if such an ideal winding can be realized, then the winding/unwinding speed of the retractable pull cords 20 can be stabilized.

When the above-described first layer winding 31 completes the process of crossing over onto the second layer winding 32, the cord section of the pull cord 20 is subjected to the tangential guiding of the inner spoke side 910, and the gradient caused by the pulling direction of the pull cord 20 enables the pull cord 20 to smoothly outwardly ascend to proceed with winding of the second layer winding 32.

Referring to FIG. 4, if the winding of the two side configured release wheels 90 results in achieving the ideal state as shown in FIG. 3, then the winding/unwinding lengths of the pull cords 20 on both sides can be equalized, and regardless of the height position the curtain blinds 70 are lowered to, the bottom rail 72 maintains a horizontal level.

Referring to FIGS. 5 and 6, which show the results of operating the release wheels 90 of the prior art, causing the laminated windings 30 to become entangled. The drawings show schematically that the first layer winding 31 is squeezed and affected by a bunching pressure FO generated by a final winding loop 320. And for ease of understanding, the drawings have been simplified, cross-section lines of the first layer winding 31, the second layer winding 32, and the third layer winding 33 are omitted, while the cross-section of the first layer winding 31 has been specially marked with the “+” symbol, and the interior of the final winding loop 320 of the second layer winding 32 has been specially marked with the “O” symbol.

Referring first to FIG. 5, one side of the structure of the release wheel 90 of the prior art is the gear wheel 91, which connects to the spoke 93 on the upper side through the flat tread 92. The tread 92 enables winding the laminated windings 30 thereon; however, such a wheel structure of the prior art often results in the windings being in disorder. It's commonly seen that the bottom rail of horizontal retractable curtain blinds loses its horizontality after several raising/lowering operations, especially in window blind sets with a curtain height of 2 to 3 meters. Because of the long lengths of the pull cords 20, multiple layers of the winding layers wound by the release wheels 90 are amassed, resulting in an accumulating an indefinite quantity of winding girths, causing the bottom rail of the lowered curtain blinds to clearly lose its horizontality, up to an angle of 45 degrees, or the windings become disordered, after which they become entangled on the outer circumference of the release wheels 90, or become knotted.

The disordered condition occurs when the pull cord 20 starts to be wound from the position of the start winding end 300 to the perpendicular inner spoke side 910 of the gear wheel 91, and becomes obstructed by the inner spoke side 910, whereupon reverse winding proceeds to complete the second layer winding 32. After the final winding loop 320 of the second layer winding 32 contacts the inner spoke side 930 of the spoke 93, it needs to ascend over and shift to proceed with reverse winding of the third layer winding 33, whereby enlarging of the winding diameter and structural friction of reverse winding will occur. Hence, the final winding loop 320 creates increased friction from the varying amount of reverse windings and must take up the burden of enlarged diameters of the windings, producing a bunching force toward a center line S.

Referring to FIG. 5-1, the bunching force acts in the direction between the first winding 310 of the first layer winding 31 and the inner spoke side 930, especially on a gap G formed after the start winding end 300 has wound round 180 degrees. Because the first winding 310 is a small angle helical winding, thus, the width of the freed gap G is smaller than the diameter of the pull cord 20, and with the addition of a bunching pressure FO, causes the final winding loop 320 to be squeezed into the space of the gap G. And because the diameter of the body section of the final winding loop 320 is larger than the gap G, thus the first winding 310 will be squeezed sideways, thereby displacing the first winding 310 toward the gear wheel 91 as shown in FIG. 6.

Referring to FIG. 6, which shows a schematic view of the disorder in the continued winding of the pull cord 20 following on from FIG. 5.

When the first layer winding 31 of the laminated windings 30 is completed and is overlaid with the second layer winding 32, then, as described above, the final winding loop 320 of the second layer winding 32 is subjected to the bunching pressure FO generated by the pulling force F exerted by the external end of the pull cord 20, and the second layer winding 32 is squeezed into the gap G along the tread 92. The lateral force component generated by the squeezing squeezes the first winding 310 of the first layer winding 31 toward the direction of the gear wheel 91, whereby the squeezing causes any one or more of a first layer co-layer winding 311 originally wound on the tread 92 to be radially outward pushed, thereby creating a helical gap 920. The whole of the first layer winding 31 then outwardly pushes the second layer winding 32, causing the surface layer of the second layer winding layer 32 to form a partially protruding convex surface. When winding the third layer winding 33, the helical winding thereof results in a disordered state of unequal circumferences due to the changes in diameter of the windings, and the possibility of a staggered winding routing 330 occurs. If this phenomenon occurs in the left and right side release wheels 90, as shown in FIG. 7, it only needs the laminated windings 30 wound around one of the release wheels 90 to be disordered, as described above, to change the winding/unwinding lengths of the two side pull cords 20, thereby affecting the height of the two ends of the bottom rail 72, meaning the lower rail 72 deviates from a horizontal position. In particular, in window blind sets that are several meters high, then the laminated windings 30 will have up to ten layers of windings, making it even easier for the bottom rail to lose horizontality, to the extent that the disordered windings will cause the laminated windings 30 to become entangled.

Referring again to FIG. 5-1, from the final winding loop 320 being squeezed into the gap G described above, it is clear that the emergence of the start winding end 300 of the pull cord 20 completes the initial first winding 310. Because of the winding gradient of the first winding 310, the start winding end 300 begins to gradually open up the helical gap G with an enlarged gradient between the side surface of that section of winding and the inner spoke side 930 of the spoke 93. The maximum width of the helical gap G is after the start winding end 300 emerges at the rear of the tread 92. Because of the bunching pressure FO generated by the final winding loop 320, there will be a high probability of producing a squeezing effect at the position of the helical gap G starting at the winding of the start winding end 300 close to a winding angle of 270 degree position, causing a lateral stacking action on the first winding 310, resulting in disordering of the first layer winding 31.

Referring to FIGS. 8 and 9, which show U.S. Pat. No. 6,561,253B1, disclosing tilt cord pulleys for Venetian blinds, wherein the design embodiment is in effect used in (see FIG. 1) the tilt pulley 40 inside the angular position adjusting device 75, which enables two free ends provided at the upper end of the drive cord loop 78 to be respectively wound therearound and joined. Operating the drive cord loop 78 enables achieving a traction frictional force that generates a torque that causes the tilt pulley 40 to rotate, whereupon the two side ladder cords 77 synchronously connectively drive the front and rear of each of the shade slats 74 to adjust the shading angles thereof.

The tilt pulley 40 has a tread 41, each side of which is provided with a side flange 42, the corner joint between each of the side flanges 42 and the tread 41 has an arc-shaped recess 44, and one of the side flanges 42 has a cord receiving notch 43 cut therein. The side flange 42 on the other side is provided with an offside notch 47. The side flanges 42 and the offside notch 47 enable the two free ends of the drive cord loop 78 to respectively wind around the tread 41 and be fastened after several windings thereof. The bottom ends of the downward hanging left cord hoop 781 and the right cord hoop 782 form a closed hoop, and as shown in FIG. 1, the drive cord loop 78 is connected to the tilt pulley 40, which is provided with a central hole 46. As shown in FIG. 1, the driving rod 76 synchronously drives the two side angular position adjusting devices 75, which further synchronously drives the two side ladder cords 77, thereby adjusting the angle of the shade slats 74.

Although the ladder cord tilt pulley 40 is used to enable changing the angular positions of the shade slats 74; however, it is the same wheel body that enables tying the cord end and winding of a tilt cord 11′, and thus can be converted to provide the winding/unwinding of the pull cord of the present invention, with the condition to guide positioning thereof; however, there is a problem of disordered winding as described below.

Referring to FIGS. 10 and 11, which show if the ladder cord tilt pulley as described above in FIGS. 8 and 9 is used to substitute for the winding/unwinding of the pull cord 20 of the present invention, there is the same problem of the wheel body causing out-of-sequence winding of the pull cord 20.

One end of the pull cord 20 is wound round starting from the start winding end 300 to proceed with winding the first layer winding 31. After completing the first layer winding 31 and upon reaching the opposite gear wheel 91, the pull cord 20 subsequently shifts outward from the inner spoke side 910 and proceeds with reverse winding of the second layer winding 32. After completing the second layer winding 32, the final winding loop 320 of the second layer winding 32 will be in the same state as shown in FIG. 5 and FIG. 6, whereby the bunching pressure FO generated toward the center line S squeezes the first winding 310 of the first layer winding 31.

Further, the corner joints between the tread 41 and the two side flanges 42 are respectively provided with the arc-shaped recesses 44; however. there is no direct contact between the arc-shaped recesses 44 and the first winding 310 that has been helically wound round about half way, thus, an arc-shaped cross-sectional space is left free. The width of the space at this angular position is less than the diameter of the final winding loop 320, and with the addition of the pulling force F of the pull cord 20, the final winding loop 320 is bunched in the direction of the center line S, resulting in (as shown in FIG. 11) the pull cord 20 being wound on the layer surface of the second layer winding 32. Moreover, the final winding loop 320 of the second layer winding 32 will tangentially press the already helical wound body section of the first winding 310 at the starting end of the first layer winding 31 that was originally orderly wound on the tread 41. Accordingly, the first layer co-layer winding 311 of the first winding 310 will be squeezed out to leave a helical gap 410, causing abnormal changes in the diameter of each winding layer of the laminated windings 30, as shown in FIG. 6, which shows the disordered windings and disarrangement in the helical windings. After such a conversion, the shortcoming of such windings can be seen in FIG. 7, which shows that the method is inexpedient for actualizing a window blind set with horizontal retractable curtain blinds requiring a winding/unwinding system that achieves the equal raising/lowering of pull cords on two sides.

### SUMMARY OF THE INVENTION

The main object of the present invention lies in providing a spring motor for a window blind set, wherein a pull cord release wheel for window blinds spring motor is configured to enable winding of a pull cord. The release wheel is mainly structured so that a ridge is perpendicular configured at a corner joint position between a tread and a spoke, wherein the ridge has a radial height is equal to or greater than half of the lamination height of a first layer winding and a second layer winding, and an axial width is greater than the diameter of the pull cord. An outer circumference ridge surface and an axial planar radial ring is provided along the ridge, and at least one inscribed tangent L is located on the tread. A center line is at the same height as the planar ring spoke of the ridge. A pull cord access hole runs through along the inscribed tangent L to provide through holes at the front and rear thereof, wherein the two through holes are formed on two sides of the tread. The two through holes are configured to respectively connect with the body of the tread and the ridge, and an open space is provided in the outgoing directions of the through holes. The outer circumference ridge surface of the ridge is used to take up a final winding loop of the second layer winding. The relatively large bunching force, generated by the shift in winding during the reverse winding process of a third layer winding, prevents squeezing caused by the disorderly winding displacement of the inner layer first winding. The present invention is applicable to a dynamic system in the window blind set with horizontal retractable curtain blinds.

A second object of the present invention lies in the pull cord access holes, each of which is formed by two conical grooves, wherein the tips of the two conical grooves coaxially inward connect back-to-back forming a pass.

A third object of the present invention lies in the pull cord access holes, which provide two channels, two center lines separately passing through a center line S of a release wheel are centrally parallel to each other.

A fourth object of the present invention lies in the pull cord access holes, wherein the respective cord emerging positions of the through holes are respectively cut out of the main body of the ridge, and are provided with a respective corresponding oblique slip-tangential inclined surface, which form open spaces. The oblique ends of the two slip-tangential inclined surfaces respectively connect to connecting side lines on two sides of a curved radial ring.

A fifth object of the invention lies in the structure of the release wheel, which is made by one-piece injection molding from plasticized material.

To enable a further understanding of said objectives, structures, characteristics, and effects, as well as the technology and methods used in the present invention and effects achieved, a brief description of the drawings is provided below followed by a detailed description of the preferred embodiments.

### BRIEF DESCRIPTION OF THE DRAWINGS

FIG. 1 is a structural front view of a window blind set of the prior art.

FIG. 2 is a basic structural three-dimensional schematic view of a torque feedback device of the prior art.

FIG. 3 is a schematic view of release wheels enabling pull cords to effectively wind laminated windings according to the prior art.

FIG. 4 is a schematic diagram of two side pull cords concurrently driving a bottom rail according to the prior art.

FIG. 5 is a winding state schematic view of the pull cord winding round the release wheel according to the prior art.

FIG. 5-1 is another winding state schematic view of the pull cord winding round the release wheel according to the prior art.

FIG. 6 is another winding state schematic view of the pull cord winding round the release wheel according to the prior art.

FIG. 7 is a schematic view of the problem caused by unequal release lengths of the left and right pull cords of the prior art.

FIG. 8 is a three-dimensional view of a ladder cord tilt pulley of the prior art.

FIG. 9 is another three-dimensional view of the ladder cord tilt pulley of the prior art.

FIG. 10 is a schematic view of the ladder cord tilt pulley enabling winding according to the prior art.

FIG. 11 is another schematic view of the ladder cord tilt pulley enabling winding according to the prior art.

FIG. 12 is a diagonal external view of the release wheel of the present invention.

FIG. 13 is a schematic view of the release wheel enabling penetration placement of a pull cord according to the present invention.

FIG. 14 is a structural three-dimensional schematic view of the release wheel of the present invention.

FIG. 15 is a three-dimensional view showing the state of the pull cord passing through the release wheel and placement therein according to the present invention.

FIG. 15-1 is a three-dimensional view showing the state of the pull cord winding round the release wheel according to the present invention.

FIG. 16 is a schematic view of the release wheel enabling winding of the laminated windings according to the present invention.

FIG. 17 is a side view of the release wheel configured with a ridge according to the present invention.

### DETAILED DESCRIPTION OF THE PREFERRED EMBODIMENTS

A pull cord release wheel for window blinds spring motor of the present invention provides a spring motor for a window blind set 10, wherein release wheels configured with pull cords 20 are mainly structured so that a ridge 54 is configured at the perpendicular angle joint position between a tread 52 and a spoke 53 thereof. The ridge has a radial height that is equal to or greater than half of the lamination height of a first layer winding 31 and a second layer winding 32 formed by winding the pull cord 20;

and the axial width of the ridge 54 is greater than the diameter of the pull cord 20. The ridge 54 is used to take up disordered windings caused by a final winding loop 320 of the second layer winding 32 crossing over and pressing the first layer winding 31.

Regarding the structure and operation function of a release wheel 50 of the present invention, in conjunction with the diagrams, the following describes the interaction between the pull cord 20 and the release wheel 50, wherein the pull cord 20 is used as the main active component, and the release wheel 50 is stationary; whereas during actual operation, the release wheel 50 is representative of actively reversing winding of the pull cord 20. In each of the drawings, because the pull cord 20 is a flexible body. the scale and operating state drawn in each of the diagrams are not entirely accurate, but maintains a representation of the operating principle. Further, the angular position terms front, rear, upper, and lower will change when extrapolated into actual practice, and will be made known during description thereof.

The release wheel 50 of the present invention is provided with anti-sag function which is capable of preventing the second layer winding 32 of the pull cord 20 from being slumped due to the bunching pressure FO when operating and also from further crowding out the first layer winding 31 which are previously being placed in order so as to resolve the defective issue.

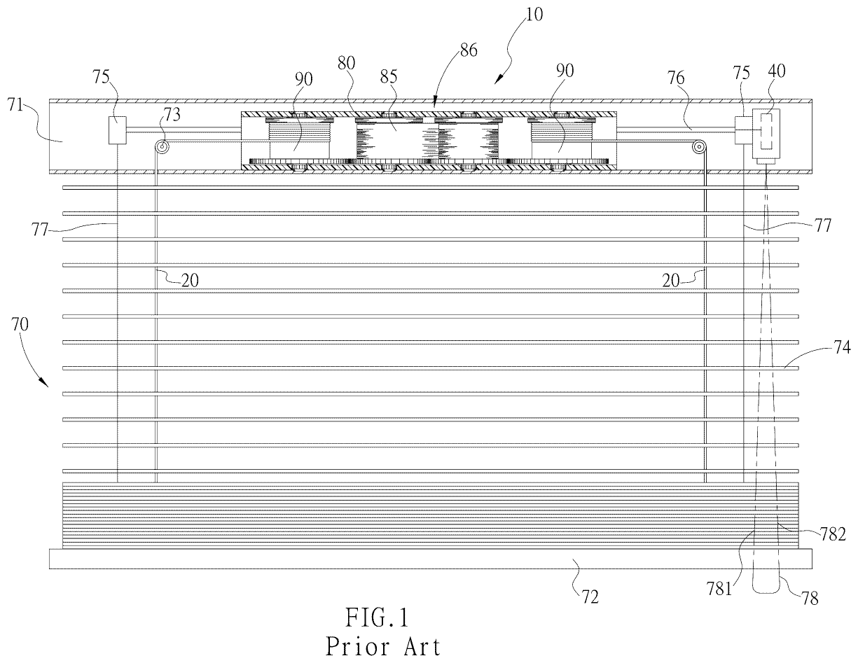

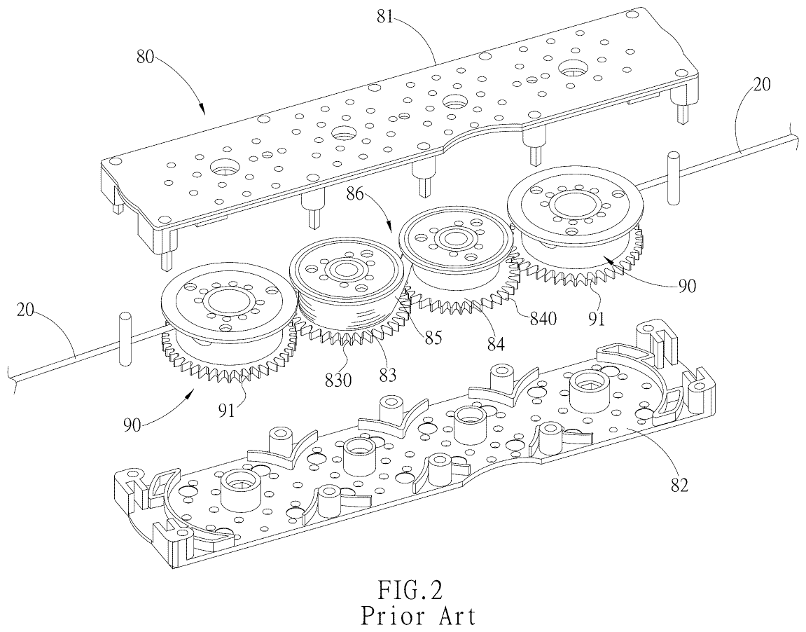

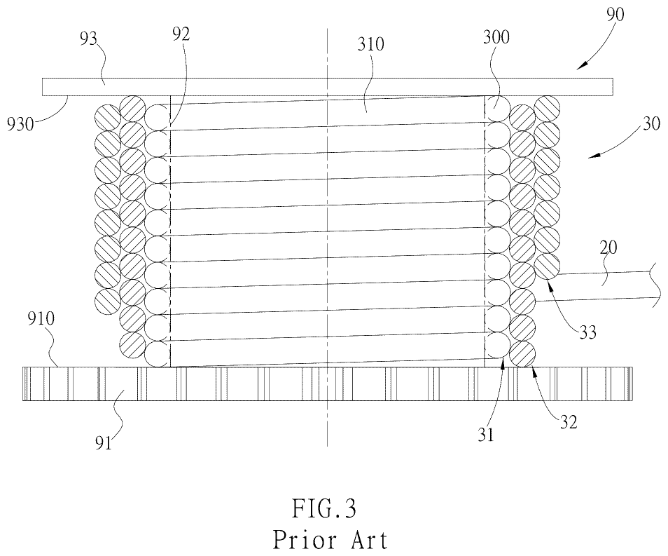

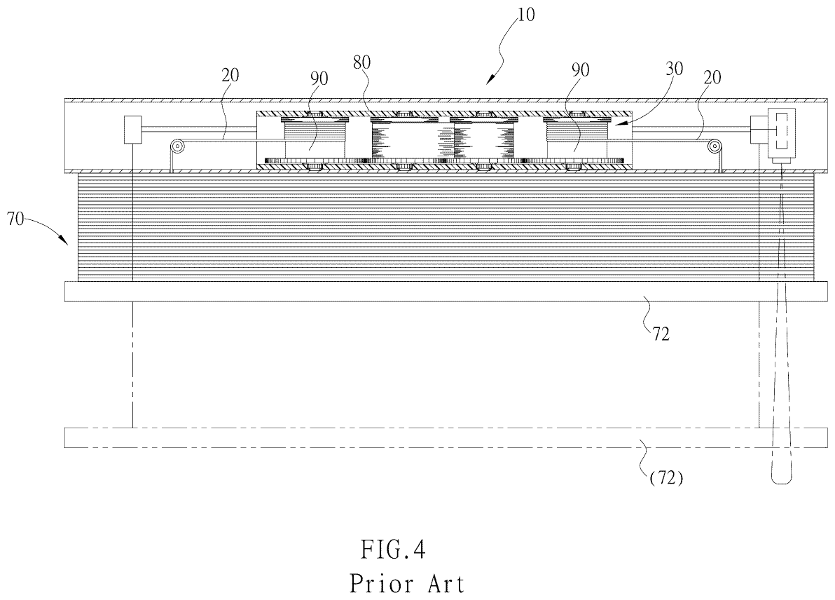

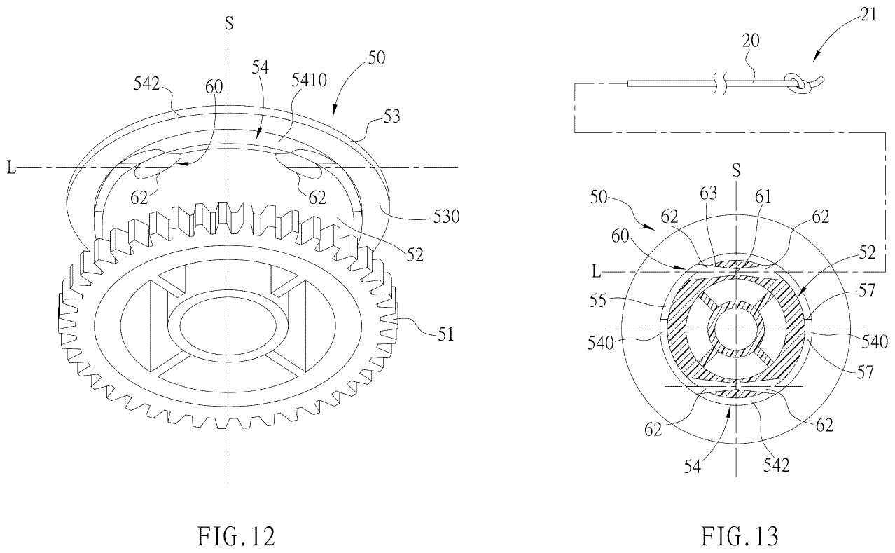

Referring first to FIG. 12, which shows the release wheel 50 of the present invention, which is a wheel body able to wind/unwind a pull cord, and replaces left and right release wheels 90 shown in FIG. 1. The main body of the release wheel 50 is provided with a gear wheel 51, and the spoke 53 is corner joined to the tread 52. The ridge 54 is annular configured at the corner joint annular region between the tread 52 and an inner spoke side 530 of the spoke 53, wherein the ridge 54 is provided with a radial outer circumference ridge surface 5410 and an axial planar radial ring 542. At least one pull cord access hole 60 at an inscribed tangent L to the tread 52 runs through the front and rear thereof, and a center line S is superimposed on the planar radial ring 542. Front and rear through holes 62 at the outer end surface structures of the pull cord access holes 60 respectively conjoin with the surface of the tread 52 and the main body of the ridge 54.

Referring to FIG. 13, the interior of each of the two through holes 62 formed at the outer ends of the pull cord access holes 60 is a conical groove 63, and the ends of the conical tips of the two conical grooves 63 are back-to-back joined to enable a connection therebetween at the center point of the inscribed tangent L, wherein the joined connected area forms a pass 61 with a minimal aperture.

The pull cord access holes 60 enable the cord end of the pull cord 20 to pass therethrough and be knot combined. The knot combined method is to pass one end of the pull cord 20 through the through hole 62 on one side of the pull cord access holes 60, and after passing through the other through hole 62, a knot 21 is tied in the pull cord 20 and then pulled in the reverse direction. Hence, because the size of the knot 21 is larger than the pass 61, the knot 21 is held fast in the pass 61, and the pull cord 20 forms a knot fitting with the release wheel 50. The direction of the reverse pulled pull cord 20 is the outgoing direction of the pull cord 20.

The pull cord access holes 60 function to facilitate threading (threading the pull cord 20) to obtain multi-directional orientations, and operate in coordination with the system operation direction. Two parallel upper/lower corresponding channels of the pull cord access holes 60 are centered on the center line S of the release wheel 50. The arrangement is such that the surface configuration of the tread 52 is provided with two sets of through holes 62 parallel and facing each other, which enable threading and selection matching with the system operation direction.

Because the pull cord access holes 60 are configured as two parallel channels, two center lines passing across the center line S of the release wheel 50 are centrally parallel to each other, and the two sets of through holes 62 corresponding thereto face each other, thus, the release wheel 50 is provided with the four through holes 62.

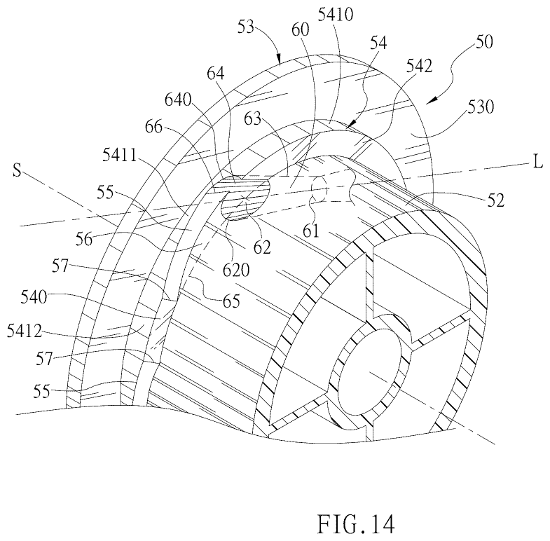

Referring to FIG. 14, which shows the through hole 62 of the pull cord access hole 60 and the tread 52, as well as the structural configuration of the surface connection with the ridge 54 thereof. A slip-tangential inclined surface 55 is formed from tangent point intersections 66 obliquely cutting connecting side lines 57, and the slip-tangential inclined surface 55 with a surface perpendicular to the center line S is cut into the section of the outgoing cord direction from the through hole 62 connecting with the ridge 54, which is used to form an open space 56 after cutting. The tread 52 is perpendicular to an inner spoke side 530, the outer circumference ridge surface 5410 of the ridge 54 is perpendicularly connected to the inner spoke side 530, and the planar radial ring 542 is perpendicularly connected to the tread 53.

The center line of the pull cord access hole 60 is superimposed on the inscribed tangent L, and is flush with the plane contour of the planar radial ring 542. Hence, the center point of the cross section of the through hole 62 of the pull cord access hole 60 intersects with an angle joint loop 65 of the original corner joint between the planar radial ring 542 and the tread 52.

The pull cord access hole 60 runs through the tread 52 in accord with the inscribed tangent L, and the front and rear of the pull cord access hole 60 are open. The through holes 62 are formed where the outer ends of the conical grooves 63 connect with the surface of the tread 52 and the ridge 54. There is an arc-shaped intersection 640 where the through hole 62 connects with the ridge 54, and a concave arc tangent plane 64 is formed according to the curvature thereat.

In addition, the slip-tangential inclined surface 55, the flat surface of which is perpendicular to the center line S, is cut into the body of the ridge 54 adjacent to the outgoing line direction of the through hole 62, thereby enabling the space formed after cutting being an open space 56, allowing the outlet of the through hole 62 to connect with the open space 56 for the pull cord 20 to thread therethrough. A curved radial ring 540 is retained after the planar radial ring 542 has been cut into to form the open space 56, and because the curved radial ring 540 was originally an integral extension of the planar radial ring 542, thus, the curved radial ring 540 and the planar radial ring 542 are equal circumferential planes.

One end of the slip-tangential inclined surface 55 connected to the curved radial ring 540 is provided with a connecting side line 57 perpendicular to the center line S; the other end is a tangent point position where the cut ridge 54 neighboring to a side of the spoke 53 connects with the through hole 62, forming a tangent point intersection 66 extending along the oblique tapered direction of the conical groove 63. Thus, the tangent point intersection 66 and the connecting side line 57 are not parallel. However, viewed microscopically, the oblique extension of the tangent point intersection 66 slightly expands outward, and thus does not affect the system operation. Thus, macroscopically, the plane of the slip-tangential inclined surface 55 can be defined and regarded as perpendicular to the center line S.

Because the open space 56 is open, the outer circumference of the ridge 54 is at the position of the open space 56, obliquely retaining a wedge-shaped connected ridge surface 5411, which becomes a part of the outer circumference ridge surface 5410.

The planar radial ring 542 is a radial ring shaped plane, which is opened up by the open space 56 to separate out the curved radial ring 540, thus, the curved radial ring 540 belongs to a portion of the planar radial ring 542.

Referring again to FIG. 13, wherein the front and rear of each of the two pull cord access holes 60 provides a total of four through holes 62 distributed on two sides. The two through holes 62 on the same side have a corresponding side outgoing line, whereat are respectively provided with the slip-tangential inclined surface 55. The oblique ends of the two slip-tangential inclined surface 55 respectively connect to the connecting side lines 57 on both sides of the curved radial ring 540.

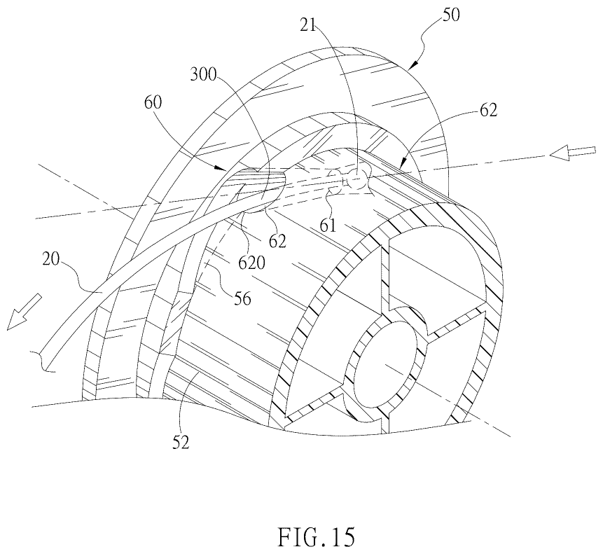

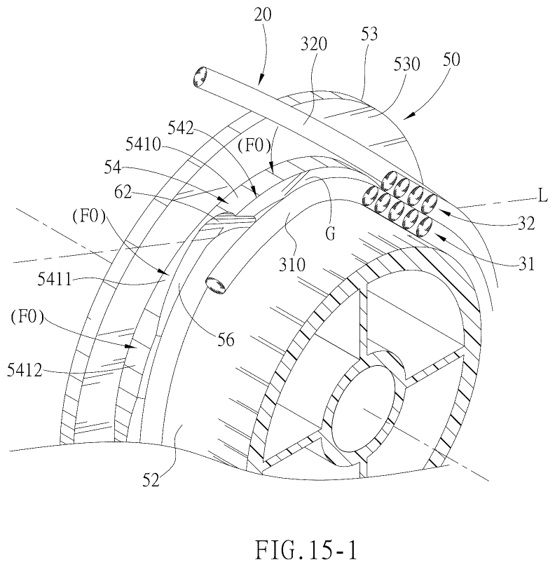

Referring to FIG. 15, as described above, after the cord end of the pull cord 20 passes through the pull cord access hole 60 of the front side through hole 62, and emerges from the angular back side of the through hole 62, as shown in the diagram, and after tying the knot 21, the pull cord 20 is pulled in the opposite direction. The knot 21 is obstructed by the pass 61, thereby achieving combining the pull cord 20 with the release wheel 50. The cord body of the pull cord 20 exits from the front side through hole 62, and the beginning of the cord body section exiting therethrough crosses the cut open space 56 and winds around the tread 52. The underside of a start winding end 300 of the pull cord 20 presses an outgoing line tangent point 620 of the through hole 62.

Referring to FIG. 15-1, which shows a three-dimensional view illustrating the state of the pull cord 20 winding round the release wheel 50, wherein the release wheel 50 enables the pull cord 20 to exit from the opening 62 and cross over the open space 56 to proceed with winding thereof. The first winding is a first winding 310, and continuous winding forms a first layer winding 31 and a second layer winding 32. A final winding loop 320 of the second layer winding 32 contacts the inner spoke side 530 of the spoke 53 at a helical angle. After being tangentially pressed by the inner spoke side 530, finally, the underside of a line section of the final winding loop 320 is wound around the outer circumference of the ridge 54. Based on the angular position shown in the diagram, the first winding round is on the outer circumference ridge surface 5410, and after passing through the through hole 62, it is wound round the wedge-shaped connected ridge surface 5411 and a reserve ridge surface 5412. Accordingly, in the final winding loop 320, most of the aforementioned bunching force acts on the ridge 54 and prevents crowding the winding sequence of the first winding 310, or the first layer winding 31 or/and the second layer winding 32.

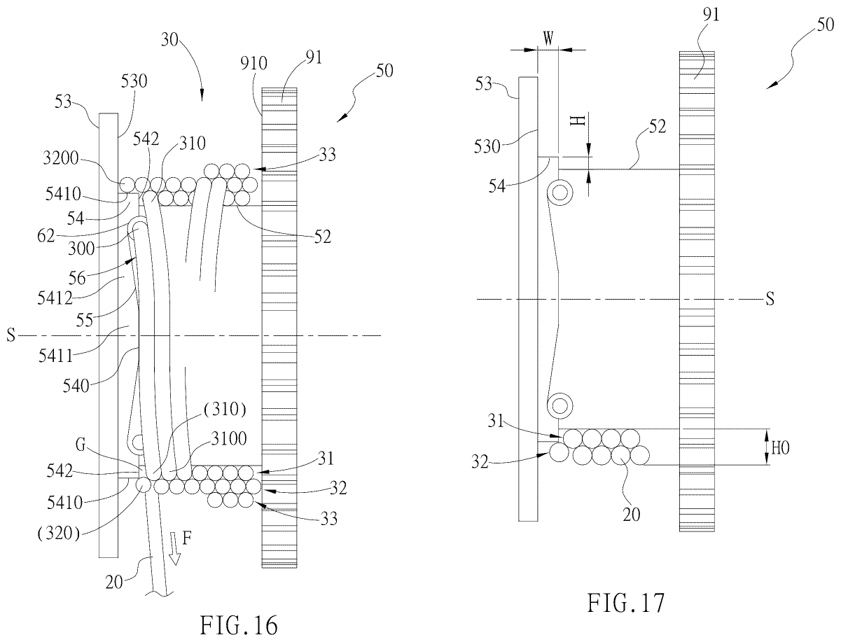

Referring to FIG. 16, after the pull cord 20 emerges from the through hole 62, the extended body section of the start winding end 300 passes over the slip-tangential inclined surface 55 configured in the open space 56, and because the pull cord 20 has a diameter value, the side surface of the cord body adjacent to the side of the slip-tangential inclined surface 55 functions in coordination with the helical angle position of the pull cord 20, pressing up against the slip-tangential inclined surface 55 and being subjected to oblique tangential pressing therefrom, thereby enabling subsequent winding placements in the direction of a right side gear wheel 91, to assume oblique angle helical winding.

The pull rope 20 is pulled by a pulling force F, and winds round by means of the release wheel 50. After completing winding round of the first winding 310, the winding placement of a following winding 3100 proceeds, winding round alignment of which is subject to the gradient parameters of the first winding 310, and in the same way winds round and contacts an inner spoke side 910 of the gear wheel 91, to complete the first layer winding 31. The body section of the first layer winding 31 that finally contacts the inner spoke side 910 then turns outward and ascends the layer surface of the first layer winding 31, and proceeds with reverse helical winding of the second layer winding 32.

The winding obliqueness of the first layer winding 31 is reverse to that of the second layer winding 32, and after completing multiple layers of windings, laminated windings 30 are formed,

In the present invention, the ridge 54 is annular configured at the perpendicular angle joint position between the tread 52 and the spoke 53, wherein the ridge 54 is provided with the outer circumference ridge surface 5410, as well as the reserve ridge surface 5412 and the wedge-shaped connected ridge surface 5411 enabling the final return of the successive winding angle of a rear section winding 3200 of the final winding loop 320 adjacent to one side of the spoke 53 of the second layer winding 32 to reach a position above the start winding end 300. Receiving the midsection span of the rear section winding 3200 enables avoiding completing an annular-type subsequent reverse winding of the final winding loop 320 to the beginning of a third layer winding 33. The relatively large mechanical misalignment change caused by the diameter enlargement when ascending the second layer winding 32 and change in direction, has been sequenced into position by the bunching pressure on the first winding 310.

According to the different winding angles of the pull cord 20, the outer circumference ridge surface 5410 or/and the surfaces of the wedge-shaped connected ridge surface 5411 and the reserve ridge surface 5412 all have the opportunity to provide spanning of the corresponding body section of the final winding loop 320 to resist the bunching pressure.

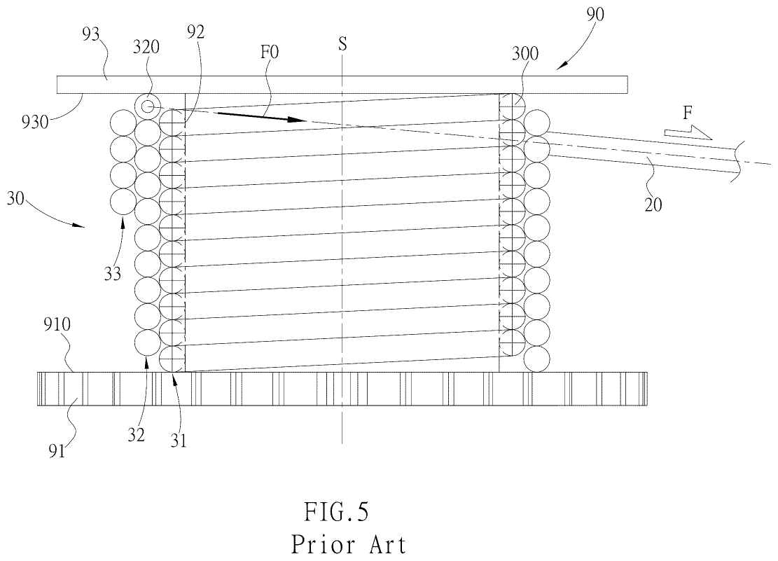

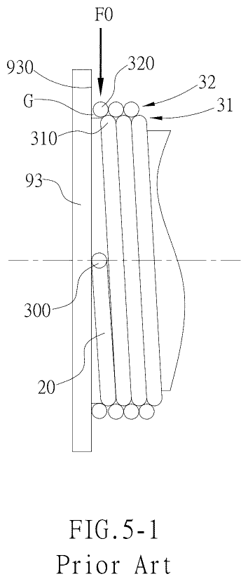

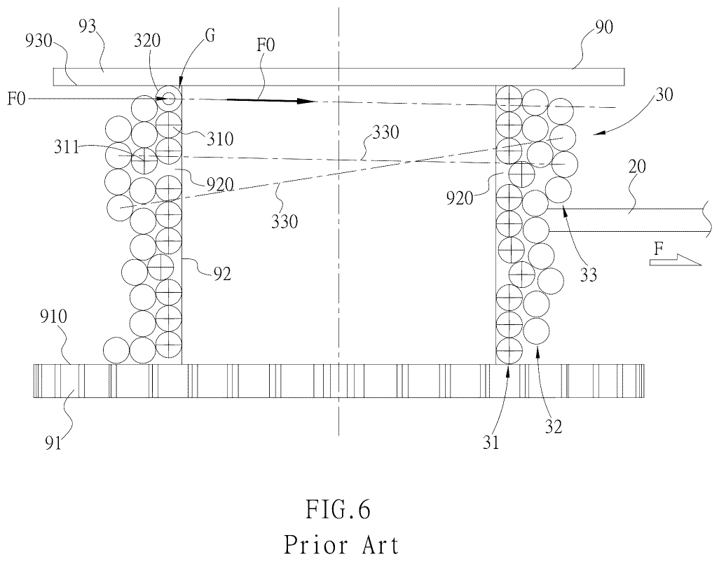

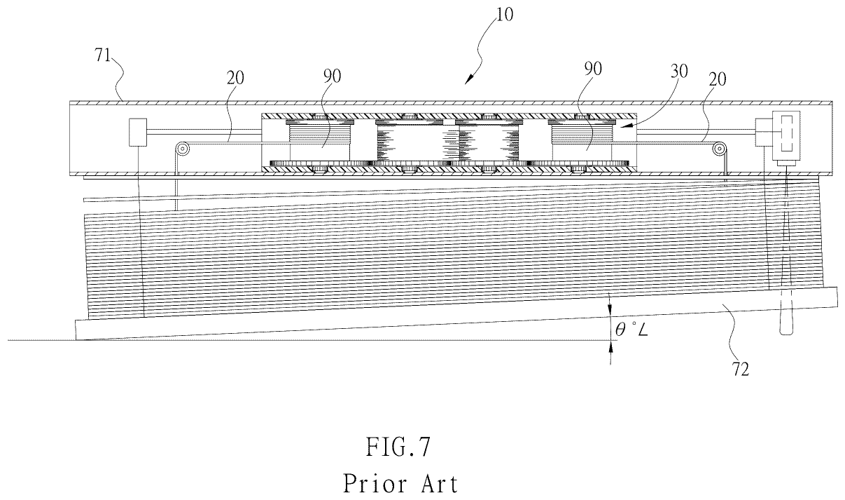

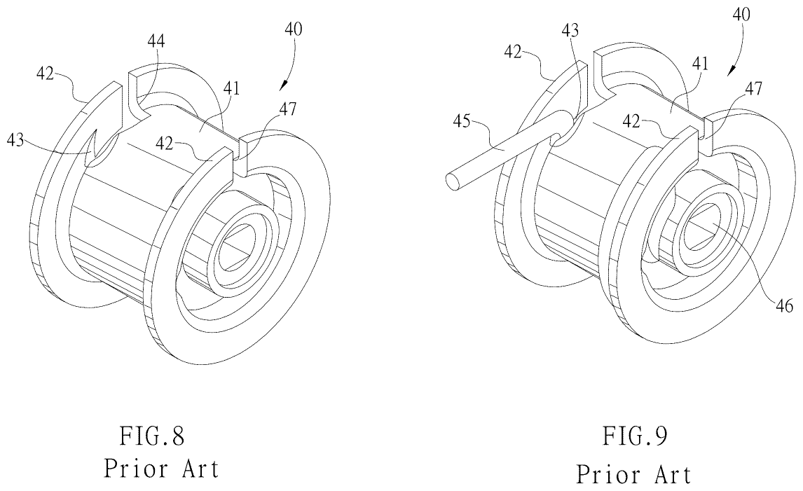

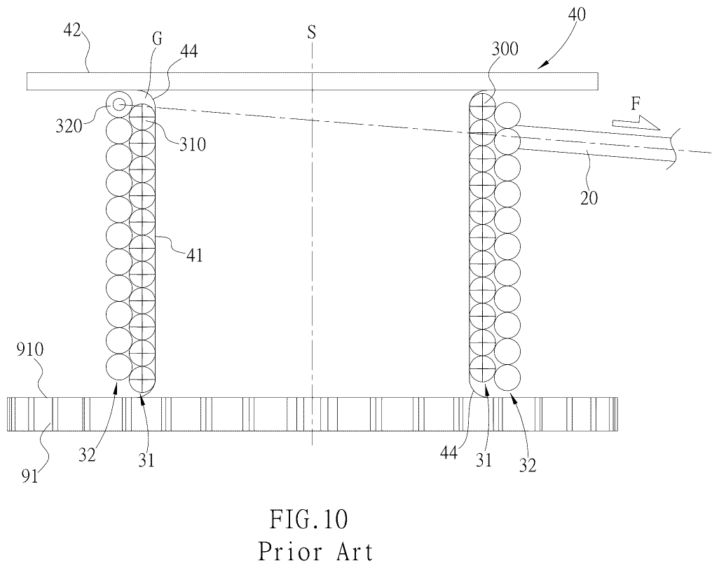

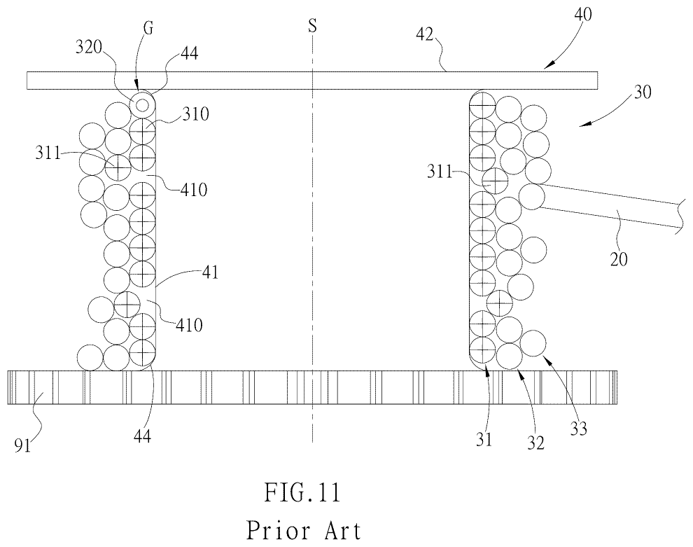

The angular position at which the above-mentioned bunching force occurs can occur at any angular position on an encircling of the first winding 310 relative to the direction of the pulling force F of the pull cord 20. The maximum harm to the sequenced angular position of the first winding 310 is after completing the second half winding of the first winding 310, and as shown in FIG. 5-1, the range of angular positions is clearly evident. Overall, the outer circumference ridge surface 5410 of the ridge 54 and the wedge-shaped connected ridge surface 5411 and the reserve ridge surface 5412 separated therefrom together co-construct a ring shape. Therefore, there is a great chance that the bunching force occurring at any angular position will be supported by the structure of the ridge 54.

Although a gap G exists between a cord section and the planar radial ring 542 when the first winding 310 is wound to the lower six o'clock position or wound around to the upper twelve o'clock position; however, because the width of the gap G is occupied by the body of the ridge 54, and with the addition of the gradient factor of the first winding 310, the maximum width of the gap G will most likely be smaller than the radius of the pull cord 20.

Because the center line of the through hole 62 is superimposed on the planar radial ring 542, thus, half of the body cord section of the start winding end 300 will lean towards the side of the through hole 62 close to the inner spoke side 530, which clearly decides winding of the cord section of the upper first winding 310. The corresponding gap with the outer circumference ridge surface 5410 is very likely smaller than the radius of the pull cord 20, with the addition of the winding direction of the second layer winding 32 being staggered to the first layer winding 31, and transposition of the winding gradient, thus, the cord body bunching force of the final winding loop 320 of the second layer winding 32 will very likely be sustained by the outer circumference ridge surface 5410.

With a configuration whereby the width of the outer circumference ridge surface 5410 is greater than the diameter of the pull cord 20, apart from the outer circumference ridge surface 5410 being able to sustain the bunching force of the final winding loop 320 described above, the idle outer circumference ridge surface 5410 close to the inner spoke side 530 enables winding of the rear section winding 3200 of the final winding loop 320. The rear section winding 3200 turns and reverse crosses the third layer winding 33, causing forces such as resistance to displacement, friction, etc. which the outer circumference ridge surface 5410 fully bears. Such effectiveness is the same as the region of the angle joint between the tread 52 and the gear wheel 91, due to the insufficient affect of the start winding end 300, instead, it is very yielding to perform a displacement movement to shift across the outer winding.

Referring to FIG. 17, which shows that the ridge 54 is connected to the inner spoke side 530 and the tread 52 with a perpendicular corner joint. Each structure is formed by one-piece injection molding from the release wheel 50, wherein the outer circumference ridge surface 5410 of ridge 54 has a width W parallel to the center line S (refer to FIG. 14) and a height H (the planar radial ring 542) perpendicular to the center line S. The height value is equal to or greater than half of a laminated height HO of the first layer winding 31 and the second layer winding 32, and the width of the ridge 54 is greater than the cross-sectional diameter of the wound pull cord 20.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A pull cord release wheel for window blinds spring motor, which provides a spring motor for a window blind set, wherein a release wheel is configured for winding/unwinding a pull cord, comprising:
a ridge, which is configured at the corner joint perpendicular position between a tread and a spoke, a body of the ridge has an outer circumference ridge surface and an axial planar radial ring, a width of the outer circumference ridge surface is greater than the diameter of the pull cord, and a height of the planar radial ring is equal to or greater than half of a laminated height after two-layer staggered winding of the pull cord;
at least one pull cord access hole that passes through the front and rear of the tread at a position of an inscribed tangent, a center line intersects with the planar radial ring, a front and rear ends of the pull cord access hole respectively form two through holes where the outer circumference ridge surface and the planar radial ring of the tread and the ridge connect; and in the direction of the through holes, slip-tangential inclined surfaces are formed from tangent point intersections obliquely cutting connecting side lines, and a space formed after cutting is an open space;
a wedge-shaped connected ridge surface and a reserve ridge surface are retained and formed after the outer circumference ridge surface is cut through by the through holes and the open space, and a curved radial ring is retained after the planar radial ring is cut through by the through holes along with the open space.

2. The pull cord release wheel for window blinds spring motor according to claim 1, wherein the pull cord access hole respectively penetrate inward forming two conical grooves that intersect forming a pass, the two conical grooves joining back-to-back along a center line.

3. The pull cord release wheel for window blinds spring motor according to claim 1, wherein each of the pull cord access holes is provided with two openings, the center lines passing therethrough cross a center line S of a release wheel and are centrally parallel to each other.

4. The pull cord release wheel for window blinds spring motor according to claim 1, wherein the tread is perpendicular to an inner spoke side, the outer circumference ridge surface of the ridge is perpendicularly connected to the inner spoke side, and the planar radial ring is perpendicularly connected to the tread.
